(19) United States
(12) Patent Application Publication
(10) Pub. No.: US 2026/0057867 A1
(43) Pub. Date: Feb. 26, 2026

(54) Wavetable Waveform Iterative Interpolation System for Digital Synthesizers

(71) Applicant: Reid Captain, Hackettstown, NJ (US)

(72) Inventor: Reid Captain, Hackettstown, NJ (US)

(21) Appl. No.: 18/815,056

(22) Filed: Aug. 26, 2024

(51) Int. Cl. G10H 7/02

(52) U.S. Cl. CPC G10H 7/02; G10H 2220/116; G10H 2250/615; G10H 2250/621

(57) ABSTRACT

A wavetable waveform interpolation system for digital synthesizers utilizes a progressively iterative method, by which an initial “anchor” waveform continuously “fades” into a final “anchor” waveform. Multiple interpolation points are positioned in progressive succession between the initial and final anchor positions in the wavetable. Each interpolation point has a normalized final position increment between it and the final anchor position, as well as a normalized initial position decrement between it and the initial anchor position. These provide the basis for weighting factors that determine the relative contributions of the initial and final waveforms at each interpolation point.

### FIELD OF INVENTION

The present invention relates generally to the field of digital synthesizers and more specifically to the generation of wavetables for musical waveforms playable on digital synthesizers.

### BACKGROUND OF THE INVENTION

Digital synthesizers are designed to play musical notes and tones based on a variety of methods, one of which uses waveforms stored in a wavetable. The quality, variety and continuity of transitions in timbre between musical tones in a wavetable is improved by interpolating between the two waveforms which constitute the initial and final “anchors” for the transition. The present invention utilizes a progressively iterative method, by which an initial anchor waveform continuously “fades” into a final anchor waveform. This method enables both variety and continuity in the waveform transitions. The present invention's progressively iterative mode of waveform evolution is an improvement over the prior art in this field, in which waveform modification is random/stochastic (e.g. Strong et al., U.S. Pat. No. 4,649,789), or based on forming sums or differences between successive waveforms (e.g. Deutsch, U.S. Pat. No. 4,351,218), or requiring a machine-learning mode of interpolation (e.g. Engel et al, U.S. Pat. No. 10,068,557).

### SUMMARY OF THE INVENTION

The present invention is a method of generating waveforms for musical notes and tones to be played on a digital synthesizer. The system involves iterative interpolation between waveforms stored as entries in a digital wavetable. These waveforms are identified by a serial position number in the wavetable. The interpolation process begins with the selection of two “anchor” waveforms between which the iterative transition is to be made. Multiple interpolation points are positioned in progressive succession between the initial anchor position and the final anchor position in the wavetable.

For each interpolation point, there is a final offset position increment between the interpolation point and the final anchor position in the wavetable, and there is an initial offset position decrement between the interpolation point and the initial anchor position in the wavetable. For example, if the initial anchor position is 0 and the final anchor position is 31, then an interpolation point at position 4 will have a final position increment of (31−4)=27 and an initial position decrement of (4−0)=4. The final position increment and the initial position decrement are then normalized to the range of +1 to 0 by division by the overall position difference between the initial and final anchor positions. In the example given above, the divisor would be (31−0)=31, so that the normalized final position increment would be (27/31)=0.871 and the normalized initial position decrement would be (4/31)=0.129.

A final offset function is determined, which is a function of the normalized final position increment. The final offset function can be either a linear, trigonometric, exponential or logarithmic function. In the example given above, exemplary final offset functions f(x) could be:

$$Linear : f ( x ) = x = 0 \text{.871}$$

$$Trigonometric : f ( x ) = {sin}^{2} ( 3 π x / 2 ) = {sin}^{2} ( 3 π * 0.87 1 / 2 ) = 0.6 \; 738$$

$$Exponential : f ( x ) = {2}^{x} - 1 = {2}^{0.871} - 1 = 0.82 \; 893$$

$$Logarithmic : f ( x ) = {Log}_{2} ( x + 1 ) = {Log}_{2} ( 0.871 + 1 ) = 0.90381$$

Similarly, an initial offset function is determined, which is a function of the normalized initial position decrement. The initial offset function can be either a linear, trigonometric, exponential or logarithmic function. In the example given above, exemplary initial offset functions f(x) could be:

$$Linear : f ( x ) = x = 0 \text{.129}$$

$$Trigonometric : f ( x ) = {sin}^{2} ( 3 π x / 2 ) = {sin}^{2} ( 3 π * 0.12 9 / 2 ) = 0.3 \; 262$$

$$Exponential : f ( x ) = {2}^{x} - 1 = {2}^{0.129} - 1 = 0.0 \; 935$$

$$Logarithmic : f ( x ) = {Log}_{2} ( x + 1 ) = {Log}_{2} ( 0.129 + 1 ) = 0.175$$

The next step of the process for each interpolation point requires the calculation of an initial anchor weighting factor, equal to the product of the amplitude of the initial anchor waveform and the final offset function. In the example given above, based on a linear f(x)=x, the initial anchor amplitude would be multiplied by 0.871, so that the initial anchor weighting factor would be weighted relatively more toward the initial anchor waveform, reflecting the proximity of the position #4 interaction point to the initial anchor position. Next, for each interpolation point a final anchor weighting factor is calculated as the product of the amplitude of the final anchor waveform and the initial offset function. Again, based on a linear f(x)=x, the final anchor amplitude would be multiplied by 0.129, so that the final anchor weighting factor would be weighted relatively less toward the final anchor waveform, reflecting the greater separation of the position #4 interaction point from the final anchor position.

Finally, for each interpolation point, a weighted average interpolated waveform is generated based on the sum of the initial anchor weighting factor and the final anchor weighting factor. In the example given above, the weighted average interpolated waveform for interpolated position #4 would have an amplitude of (0.871×Initial Anchor Amplitude)+(0.129×Final Anchor Amplitude), reflecting the greater weight given to the initial anchor waveform as compared the final anchor waveform due to the closer proximity of the interpolation position #4 to the former.

However, in the iterative “fading” process, as successive interpolation points approach the final anchor waveform, the weighted average interpolated waveform is increasingly weighted toward the final anchor waveform and less toward the initial anchor waveform, so that the iterative process generates a series of interpolated waveforms that continuously transition from the initial anchor waveform to the final anchor waveform. This series of weighted average interpolated waveforms are stored in the wavetable as wavetable entries, which are then accessed to produce musical notes and tones on a digital synthesizer, either in a specified sequence based on the waveforms' interpolated positions in the wavetable, or in a random sequence. The specified sequence is either (a) a forward sequence from lower to higher position numbers on the wavetable, or (b) a reverse sequence from higher to lower position numbers on the wavetable, or (c) a cyclical sequence that cycles back and forth between the forward sequence and the reverse sequence.

Optionally, the digital synthesizer can incorporate a touchscreen by which the initial anchor waveform and/or the final anchor waveform can be edited prior to the interpolation process.

The foregoing summarizes the general design features of the present invention. In the following sections, specific embodiments of the present invention will be described in some detail. These specific embodiments are intended to demonstrate the feasibility of implementing the present invention in accordance with the general design features discussed above. Therefore, the detailed descriptions of these embodiments are offered for illustrative and exemplary purposes only, and they are not intended to limit the scope either of the foregoing summary description or of the claims which follow.

### BRIEF DESCRIPTION OF THE DRAWINGS

FIG. 1 is a flowchart describing the process of editing waveforms, preliminary to the waveform interpolation process, according to one embodiment of the present invention;

FIG. 2 is a flowchart describing the waveform interpolation process, according to one embodiment of the present invention;

FIG. 3 depicts a series of waveforms representing the iterative “fading” process between an initial anchor sawtooth waveform and a final anchor sine waveform, according to one embodiment of the present invention;

FIG. 4 is a flowchart describing the process of synthesizer playback of interpolated wavetable entries, according to one embodiment of the present invention;

FIGS. 5A and 5B depict touchscreen editing of waveforms, according to one embodiment of the present invention.

### DETAILED DESCRIPTION OF THE PREFERRED EMBODIMENT

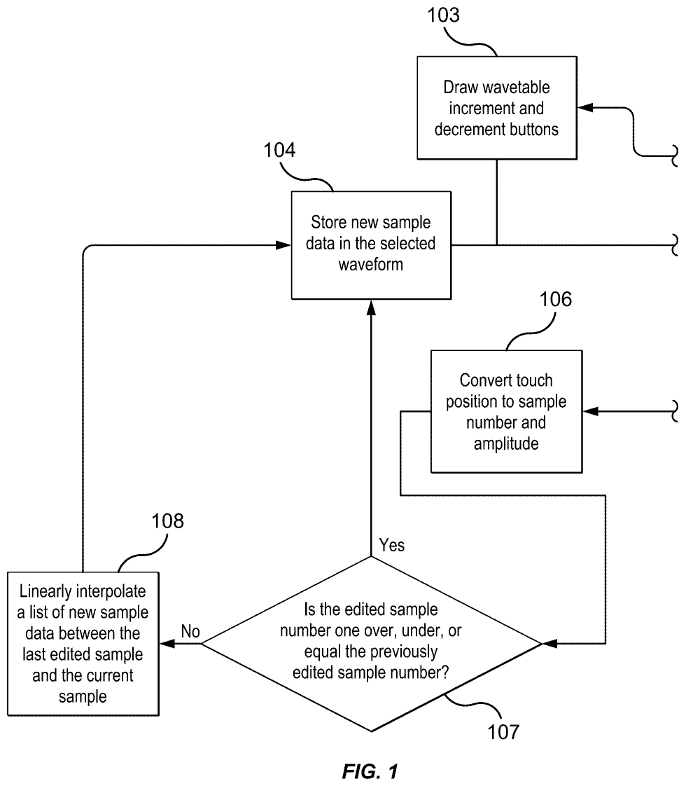

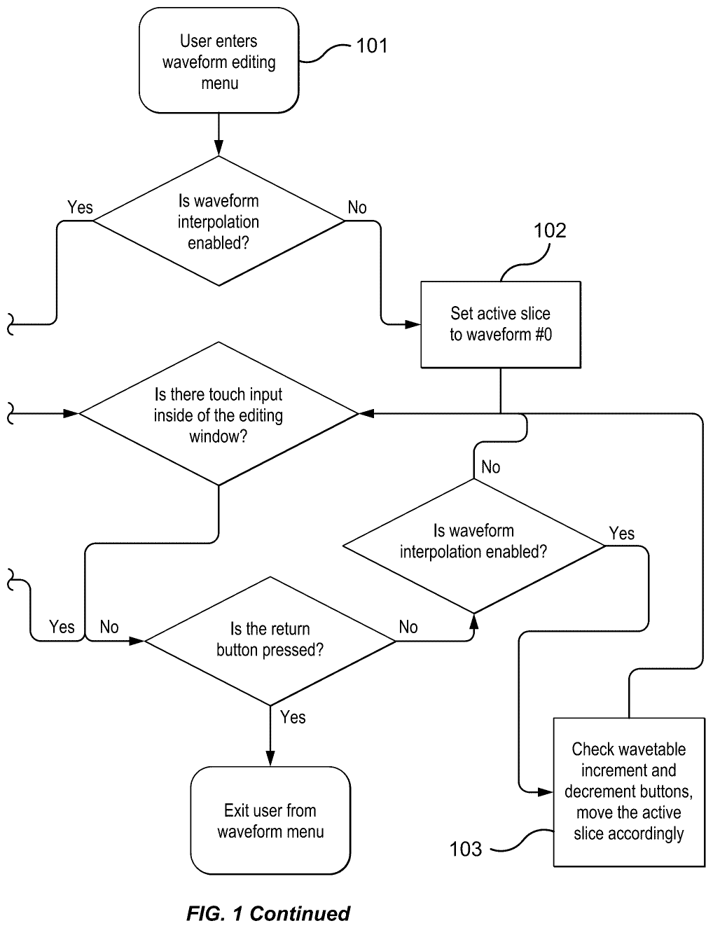

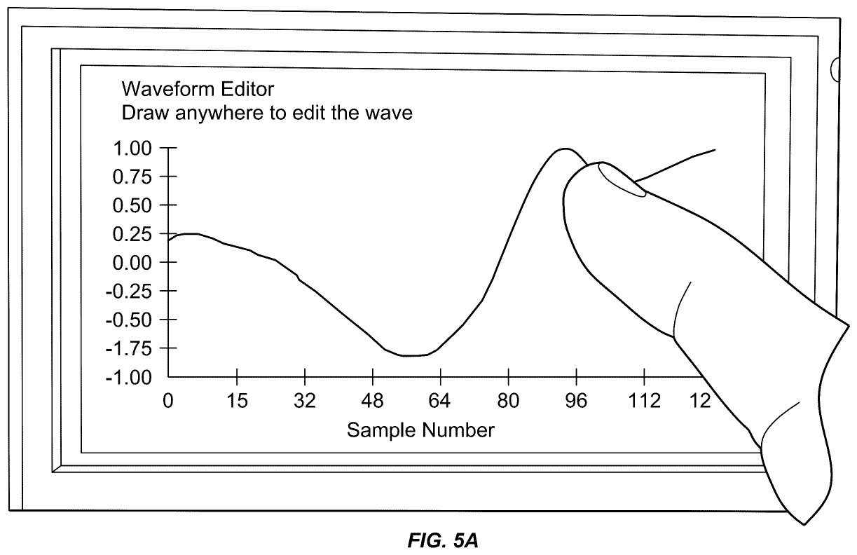

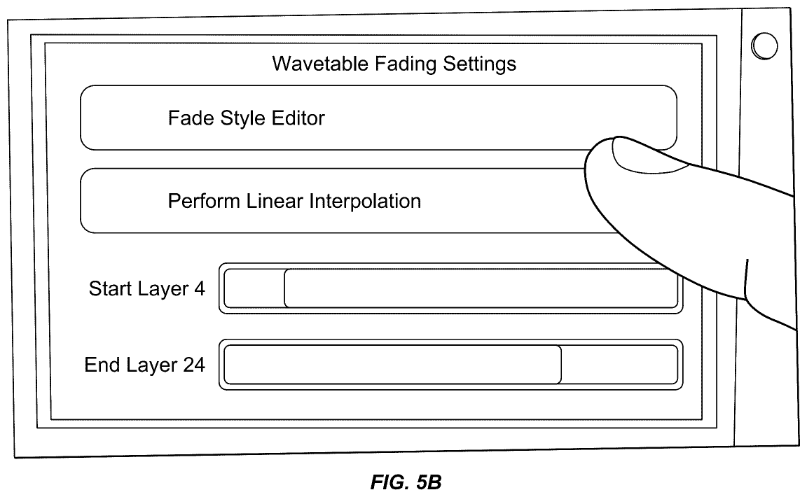

The flowchart of FIG. 1 depicts an exemplary process of editing waveforms stored in the wavetable preliminary to the waveform interpolation process. After the user enters the waveform editing menu 101, if waveform interpolation is not enabled, then the active wavetable address is by default set at position #0 102. If waveform interpolation is enabled, then preset wavetable position increments and decrements are created to enable selection of a waveform in the wavetable 103. The process then proceeds through a touchscreen input window 106 to allow the amplitude of specific waveforms to be edited. An example of the touchscreen waveform input window is shown in FIG. 5A. After touchscreen waveform editing, the edited point is checked for x-position locality to the previously edited point 107, and if it is an increment, decrement, or equivalent to the previous x-position, it is saved directly into the wavetable 104, but if it is not local to the x-position as previously defined, a series of points are created between the current and previous positions using linear interpolation to “fill in the gap” 108. This ensures that any delay in touchscreen polling will not create noticeable gaps between edited wavetable positions in the event the user is inputting near-adjacent entries. Finally, the generated point data is stored in the wavetable at the previously interpolated positions and amplitudes 104.

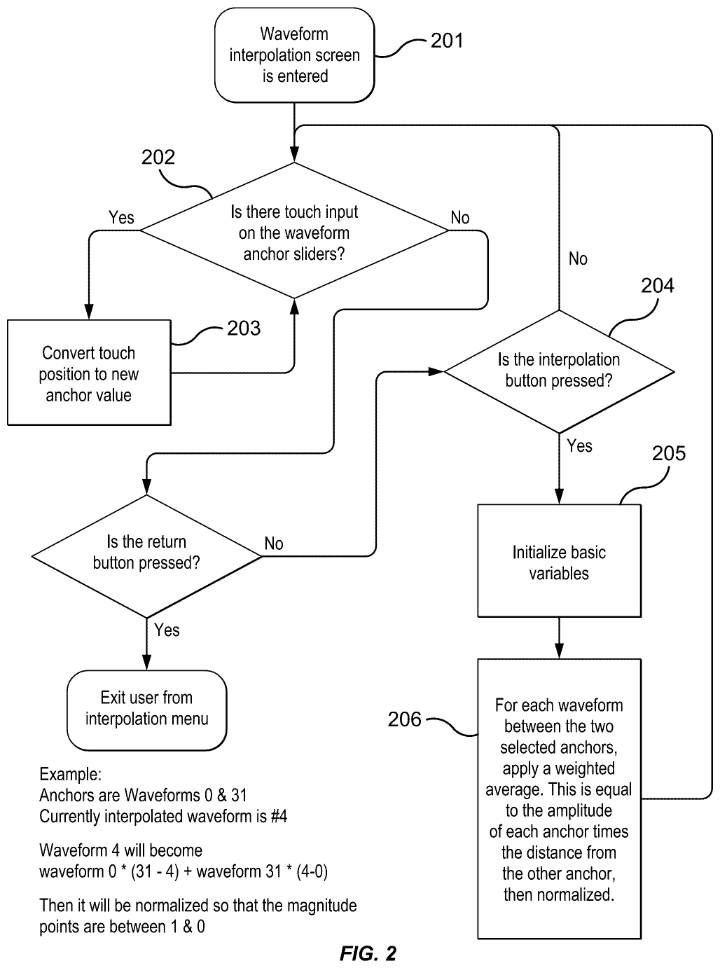

The flowchart of FIG. 2 depicts an exemplary waveform interpolation process. After the user enters the interpolation menu 201, waveform anchor sliders are to set the initial and final anchor waveform positions in the wavetable 202 203. An example of the waveform anchor sliders is shown in FIG. 5B. When the interpolation process is initialized 204 205, a weighted average between the initial and final anchors is applied to the respective anchor amplitudes to derive the intermediate interpolated waveform 206.

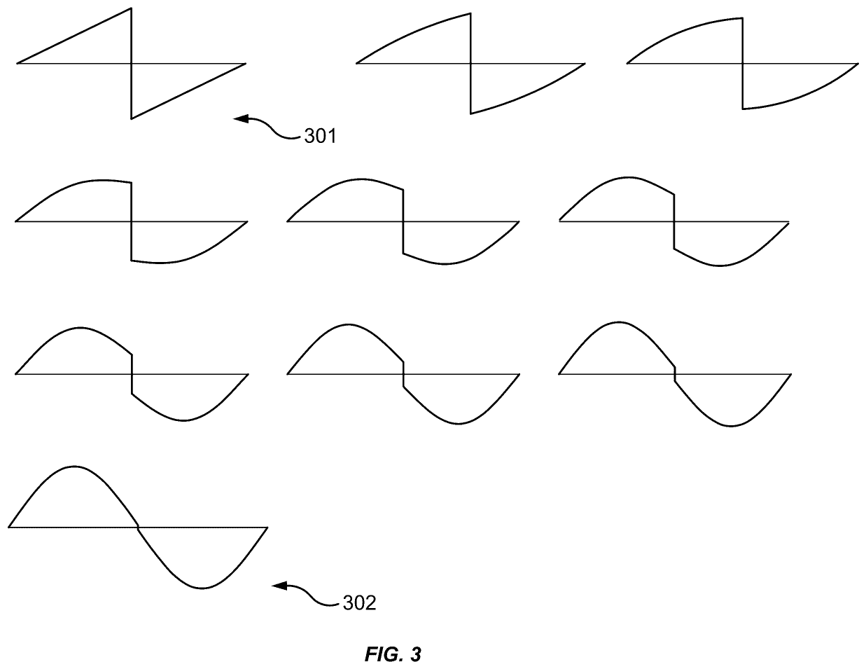

FIG. 3 depicts an exemplary series of interpolated waveforms, which appear to “fade” between an initial anchor sawtooth waveform 301 and a final anchor sine waveform 302.

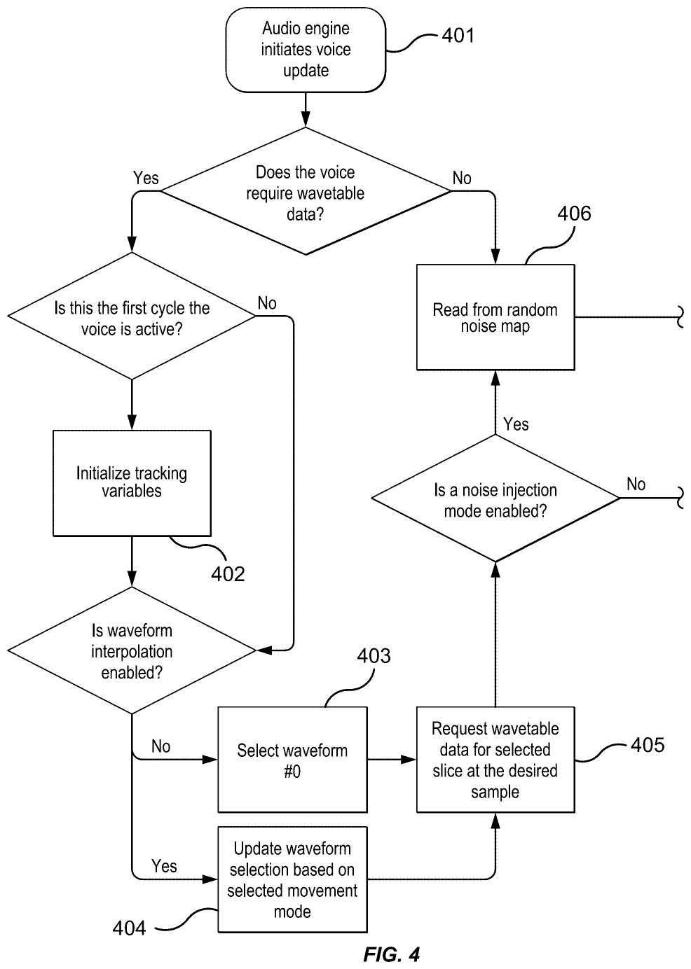

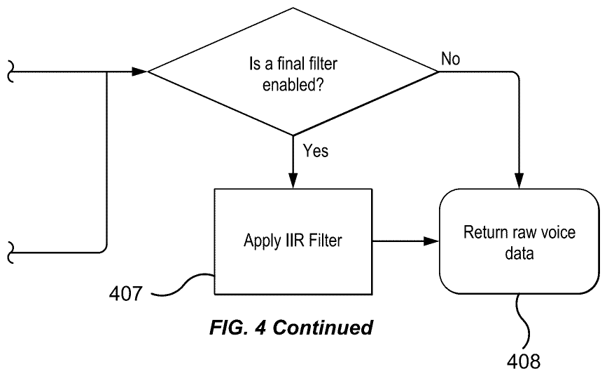

The flowchart of FIG. 4 describes the process of synthesizer playback of interpolated wavetable entries. After activating the audio engine 401 and initializing the select voice 402, waveforms are selected based on the specified waveform sequence 403 404, and wavetable entries are accessed 405. After noise injection and filtering, 406 407, the audio output is returned to the audio engine for final mixing and playback 408.

Although the preferred embodiment of the present invention has been disclosed for illustrative purposes, those skilled in the art will appreciate that many additions, modifications and substitutions are possible, without departing from the scope and spirit of the present invention as defined by the accompanying claims.

What is claimed is:

1. A method of generating waveforms for musical notes and tones to be played by a digital synthesizer, which method comprises the following steps:
(a) providing a wavetable containing multiple waveforms, arranged in serial waveform positions;
(b) selecting from the wavetable an initial anchor waveform having an initial anchor position and an initial anchor amplitude;
(c) selecting from the wavetable a final anchor waveform having a final anchor position and a final anchor amplitude;
(d) positioning multiple interpolation points between the initial anchor waveform and the final anchor waveform, wherein the multiple interpolation points have interpolated waveform positions which incrementally approach the final anchor position from the initial anchor position;
(e) for each interpolation point, determining a final offset function, wherein the final offset function is a function of a normalized final position increment between the interpolation point and the final anchor position;
(f) for each interpolation point, determining an initial offset function, wherein the initial offset function is a function of a normalized initial position decrement between the interpolation point and the initial anchor position;
(g) for each interpolation point, calculating an initial anchor weighting factor equal to a product of the initial anchor amplitude and the final offset function;
(h) for each interpolation point, calculating a final anchor weighting factor equal to a product of the final anchor amplitude and the initial offset function; and
(i) for each interpolation point, generating a weighted average interpolated waveform based on the sum of the initial anchor weighting factor and the final anchor weighting factor, so as to generate a series of weighted average interpolated waveforms corresponding to the multiple interpolation points.

2. The method according to claim 1, comprising the following additional steps:
(j) storing the series of weighted average interpolated waveforms in the wavetable as wavetable entries; and
(k) accessing the wavetable to play on the digital synthesizer musical notes and tones corresponding to the weighted average interpolated waveforms, by fading between wavetable entries in a specified waveform sequence or in a random sequence.

3. The method according to claim 1, wherein the final offset function and the initial offset function are linear, trigonometric, exponential or logarithmic functions.

4. The method according to claim 2, wherein the final offset function and the initial offset function are linear, trigonometric, exponential or logarithmic functions.

5. The method according to claim 2, wherein the specified waveform sequence is selected from the group consisting of: (i) a forward sequence from lower to higher waveform positions in the wavetable, (ii) a reverse sequence from higher to lower waveform positions in the wavetable, and (iii) a cyclical sequence that cycles back and forth between the forward sequence and the reverse sequence.

6. The method according to claim 4, wherein the specified waveform sequence is selected from the group consisting of: (i) a forward sequence from lower to higher waveform positions in the wavetable, (ii) a reverse sequence from higher to lower waveform positions in the wavetable, and (iii) a cyclical sequence that cycles back and forth between the forward sequence and the reverse sequence.

7. The method according to claim 1, wherein the initial anchor waveform and/or the final anchor waveform can be edited on a touchscreen incorporated in the digital synthesizer.

8. The method according to claim 2, wherein the initial anchor waveform and/or the final anchor waveform can be edited on a touchscreen incorporated in the digital synthesizer.

9. The method according to claim 3, wherein the initial anchor waveform and/or the final anchor waveform can be edited on a touchscreen incorporated in the digital synthesizer.

10. The method according to claim 4, wherein the initial anchor waveform and/or the final anchor waveform can be edited on a touchscreen incorporated in the digital synthesizer.

11. The method according to claim 5, wherein the initial anchor waveform and/or the final anchor waveform can be edited on a touchscreen incorporated in the digital synthesizer.

12. The method according to claim 6, wherein the initial anchor waveform and/or the final anchor waveform can be edited on a touchscreen incorporated in the digital synthesizer.
